(19) United States
(12) Patent Application Publication
(10) Pub. No.: US 2016/0315305 A1
(43) Pub. Date: Oct. 27, 2016

(54) Preconditioned Bus Bar Interconnect System

(71) Applicant: ATIEVA, INC., Menlo Park, CA (US)

(72) Inventors: Stephan Carl Wintner, San Francisco, CA (US); Martin Forest Eberhard, Woodside, CA (US)

(73) Assignee: ATIEVA, INC., Menlo Park, CA (US)

(21) Appl. No.: 14/708,966

(22) Filed: May 11, 2015

Related U.S. Application Data
(63) Continuation-in-part of application No. 14/691,932, filed on Apr. 21, 2015.
Application No. 14/691,932 is a continuation-in-part of application No. 14/692,285, filed on Apr. 21, 2015, now Pat. No. 9,431,644.

(51) Int. Cl. H01M 2/30

(52) U.S. Cl. CPC H01M 2/30

(57) ABSTRACT

A method is provided for interconnecting the batteries in a battery pack in a manner that is designed to minimize damage and contamination of the contact surfaces of the interconnect and the battery terminal, thereby minimizing connection resistance and increasing interconnect reliability.

### CROSS-REFERENCE TO RELATED APPLICATION

This application is a continuation-in-part of U.S. patent application Ser. No. 14/691,932, filed 21 Apr. 2015, and a continuation-in-part of U.S. patent application Ser. No. 14/692,285, filed 21 Apr. 2015, the disclosures of which are incorporated herein by reference for any and all purposes.

### FIELD OF THE INVENTION

The present invention relates generally to battery packs and, more particularly, to a battery pack bus bar interconnect system.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. One of the most common approaches to achieving a low emission, high efficiency car is through the use of a hybrid drive train in which an internal combustion engine is combined with one or more electric motors. An alternate approach that is intended to reduce emissions even further while simultaneously decreasing drive train complexity is one in which the internal combustion engine is completely eliminated from the drive train, thus requiring that all propulsive power be provided by one or more electric motors. Regardless of the approach used to achieve lower emissions, in order to meet overall consumer expectations it is critical that the drive train maintains reasonable levels of performance, range, reliability, and cost.

Irrespective of whether an electric vehicle (EV) uses a hybrid or an all-electric drive train, the battery pack employed in such a car presents the vehicle's design team and manufacturer with various trade-offs from which to select. For example, the size of the battery pack affects the vehicle's weight, performance, driving range, available passenger cabin space and cost. Battery performance is another characteristic in which there are numerous trade-offs, such as those between power density, charge rate, life time, degradation rate, battery stability and inherent battery safety. Other battery pack design factors include cost, both on a per battery and per battery pack basis, material recyclability, and battery pack thermal management requirements.

In order to lower battery pack cost and thus the cost of an EV, it is critical to reduce both component cost and assembly time. An area of pack fabrication that has a large impact on assembly time, especially for large packs utilizing small form factor batteries, is the procedure used to connect the batteries together, where the batteries are typically grouped together into modules which are then interconnected within the pack to achieve the desired output power. In a conventional pack, the high current interconnects that electrically connect each terminal of each battery to the corresponding bus bar are typically comprised of wire, i.e., wire bonds. Unfortunately wire bonding is a very time consuming, and thus costly, process and one which may introduce reliability issues under certain manufacturing conditions.

Accordingly, what is needed is a robust interconnect that allows the battery pack to be quickly and efficiently assembled, thus lowering manufacturing time and cost. The present invention provides such an interconnect design and manufacturing process.

### SUMMARY OF THE INVENTION

The present invention provides a method of electrically interconnecting a plurality of batteries, the method comprising the steps of (i) fabricating a bus bar comprised of a plurality of interconnects configured to include at least one interconnect per battery, where the at least one interconnect includes (a) a first end portion formed as an extension of the bus bar and (b) a second end portion distal from the first end portion and configured to be attached to a battery terminal of a corresponding battery of the plurality of batteries, where the second end portion is comprised of a contact tab; (ii) pre-shaping the contact tab of the at least one interconnect prior to connecting it to the battery terminal, where the contact tab is shaped to form an angled contact surface comprised of a sacrificial contact surface and a primary contact surface, where the primary contact surface is distal from the sacrificial contact surface, and where prior to contacting the at least one interconnect to the battery terminal a first separation distance between the sacrificial contact surface and the battery terminal is less than a second separation distance between the primary contact surface and the battery terminal; (iii) contacting the sacrificial contact surface to the battery terminal; (iv) contacting the primary contact surface to the battery terminal, where the step of contacting the primary contact surface to the battery terminal is performed after completion of the step of contacting the sacrificial contact surface to the battery terminal; and (v) attaching the primary contact surface to the battery terminal in order to form an electrical connection between the primary contact surface and the battery terminal. The step of attaching the primary contact surface to the battery terminal may utilize a technique selected from the group consisting of laser welding, e-beam welding, resistance welding, ultrasonic welding thermocompression bonding and thermosonic bonding. The sacrificial contact surface may also be attached to the battery terminal utilizing a technique selected from the group consisting of laser welding, e-beam welding, resistance welding, ultrasonic welding thermocompression bonding and thermosonic bonding.

In other aspects, the step of fabricating the bus bar may further comprise fabricating the at least one interconnect as a tab extending from an edge of the bus bar. The step of fabricating the bus bar may further comprise fabricating the bus bar and the plurality of interconnects from a single piece of material.

In another aspect, the bus bar may be moved to a first position relative to the plurality of batteries, thereby causing the sacrificial contact surface to touch the battery terminal. Additionally, after the bus bar has been moved to the first position, the bus bar may be moved to a second position relative to the plurality of batteries, thereby causing the primary contact surface to touch the battery terminal.

In another aspect, the plurality of batteries may be moved to a first position relative to the bus bar, thereby causing the sacrificial contact surface to touch the battery terminal. Additionally, after the plurality of batteries has been moved to the first position, the plurality of batteries may be moved to a second position relative to the bus bar, thereby causing the primary contact surface to touch the battery terminal.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 is a schematic diagram of a battery pack with bus bars above and below the battery cells;

FIG. 2 is a schematic diagram of a battery pack with bus bars adjacent to the positive terminals of the battery cells;

FIG. 3 provides a top view of a portion of a battery assembly, and in particular of the bus bar connections to a single battery;

FIG. 4 provides a side view of one of the bus bars and the associated interconnect shown in FIG. 3 prior to initiation of the interconnect attachment process;

FIG. 5 provides a second side view of the assembly shown in FIG. 4, this view being orthogonal to the view provided by FIG. 4;

FIG. 6 provides a side view of the assembly, similar to the view shown in FIG. 5, after initial contact is made between the sacrificial contact surface of the interconnect and the battery terminal;

FIG. 7 provides a side view of the assembly, similar to the view shown in FIGS. 5 and 6, as the interconnect attachment process continues;

FIG. 8 provides a side view of the assembly, similar to the view shown in FIGS. 5-7, after final contact is made between both the primary and sacrificial contact surfaces of the interconnect and the battery terminal;

FIG. 9 illustrates the embodiment shown in FIG. 3 with the primary contact surfaces of the interconnects welded to the underlying battery terminals while the sacrificial contact surfaces of the interconnects remain unattached; and

FIG. 10 illustrates the embodiment shown in FIG. 3 with both the primary and sacrificial contact surfaces of the interconnects welded to the underlying battery terminals.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps or calculations, these steps or calculations should not be limited by these terms, rather these terms are only used to distinguish one step or calculation from another. For example, a first calculation could be termed a second calculation, and, similarly, a first step could be termed a second step, without departing from the scope of this disclosure.

In the following text, the terms “battery”, “cell”, and “battery cell” may be used interchangeably and may refer to any of a variety of different battery configurations and chemistries. Typical battery chemistries include, but are not limited to, lithium ion, lithium ion polymer, nickel metal hydride, nickel cadmium, nickel hydrogen, nickel zinc, and silver zinc. The terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

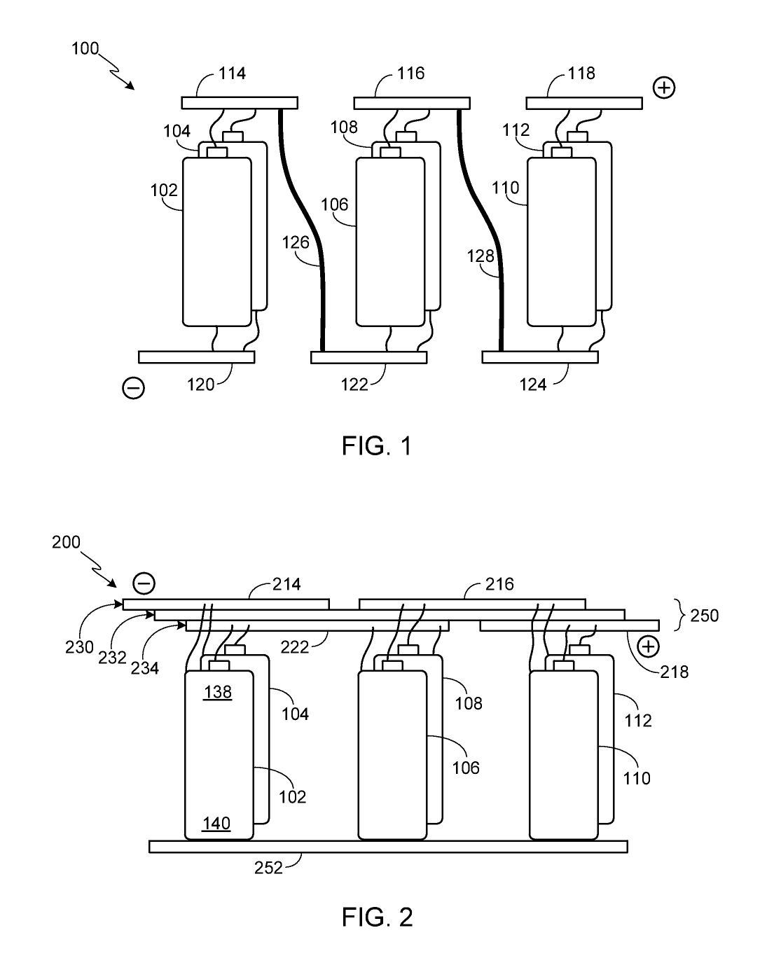

FIG. 1 illustrates an exemplary battery pack 100 illustrating a common battery pack configuration. As shown, battery pack 100 includes a first group of batteries 102 and 104 connected in parallel, a second group of batteries 106 and 108 connected in parallel, and a third group of batteries 110 and 112 connected in parallel. The first, second and third groups of batteries are connected in series. Bus bars 114, 116, 118, 120, 122, 124 are used to connect the batteries in this parallel and series arrangement. Each of the bus bars is coupled to the respective batteries with one or more interconnects. A relatively thick wire 126 couples the second bus bar 114 to the third bus bar 122, making a series connection between the first and second battery groups, while a second relatively thick wire 128 couples the fourth bus bar 116 to the fifth bus bar 124, making a series connection between the second and third battery groups. As a result, the first bus bar 120 is the negative terminal while the sixth bus bar 118 is the positive terminal for battery pack 100.

The use of bus bars at both ends of the batteries as illustrated in FIG. 1 requires a relatively complex manufacturing process in order to (i) attach the battery interconnects between the battery end surfaces and the bus bars, and (ii) attach the wires (e.g., wires 126 and 128) that couple the upper bus bars to the lower bus bars. Wires 126 and 128 are also problematic in the sense that they can introduce parasitic resistance into the current path, which in turn can introduce a voltage drop under high current drain conditions. Additionally this configuration prevents, or at least limits, the ability to efficiently remove battery pack heat by affixing a heat sink to a battery end surface.

FIG. 2 illustrates a battery pack 200 utilizing an alternate battery pack configuration in which all the bus bars are proximate to one end of the battery pack, thus enabling efficient heat removal from the other end of the battery pack. Furthermore, by locating bus bars 214, 216, 218 and 222 proximate to one end of the batteries, fewer bus bars are required than in battery pack 100. The relatively thick wires 126 and 128 from the upper bus bars to the lower bus bars are also eliminated in the embodiment shown in FIG. 2.

Access to both the positive and negative terminals in battery pack 200 is at one end of the cells, i.e., at the top end of the cells, where the bus bars are coupled to the positive and negative terminals using battery interconnects. As in the prior arrangement, the first group of batteries 102 and 104 are connected in parallel, the second group of batteries 106 and 108 are connected in parallel, and the third group of batteries 110 and 112 are connected in parallel. The first, second and third groups of batteries are connected in series. Bus bars 214, 216, 218, 222 are used to couple the batteries in this parallel and series arrangement. Specifically, starting with the negative terminal of battery pack 200, a first bus bar 214 is connected to the negative terminals of the first group of batteries 102 and 104 while a second bus bar 222 is connected to the positive terminals of the same group of batteries 102 and 104, both at the top end portion 138 of each of the batteries. The first and second bus bars 214 and 222 couple the first group of batteries 102 and 104 in parallel. Similarly, the second bus bar 222 and the third bus bar 216 couple the second group of batteries 106 and 108 in parallel, while the third bus bar 216 and the fourth bus bar 218 couple the third group of batteries 110 and 112 in parallel. Series connections between battery groups are formed by the bus bars, specifically the second bus bar 222 connects the positive terminals of the first group of batteries 102 and 104 to the negative terminals of the second group of batteries 106 and 108; and the third bus bar 216 connects the positive terminals of the second group of batteries 106 and 108 to the negative terminals of the third group of batteries 110 and 112. The fourth bus bar 218 is the positive terminal of the battery pack 200.

In battery pack 200 the bus bars are arranged in a layer stack 250. In this stacking arrangement first bus bar 214 and third bus bar 216, which are separated by an air gap or other electrical insulator to prevent short circuiting, are placed in a first layer 230. Similarly, second bus bar 222 and fourth bus bar 218, which are also separated by a gap or insulator, are placed in a third layer 234. Disposed between layers 230 and 234 is an electrically insulating layer 232. To simplify fabrication, the layer stack may be formed using layers of a circuit board, e.g., with the bus bars made of (or on) copper layers or other suitable conductive metal (such as aluminum) and the insulating layer made of resin impregnated fiberglass or other suitable electrically insulating material. It should be understood that layer stack 250 is simply an exemplary stack and that alternate bus bar arrangements may be used.

In a preferred embodiment, and as shown in the figures, the batteries have a projecting nub as a positive terminal at the top end of the battery and a can or casing that serves as the negative battery terminal. The batteries are preferably cylindrically shaped with a flat bottom surface. Typically a portion of the negative terminal is located at the top end of the cell, for example due to a casing crimp which is formed when the casing is sealed around the contents of the battery. This crimp or other portion of the negative terminal at the top end of the battery provides physical and electrical access to the battery's negative terminal. The crimp is spaced apart from the peripheral sides of the projecting nub through a gap that may or may not be filled with an insulator.

Preferably in a battery pack such as battery pack 200 in which the battery connections are made at one end of the cells (e.g., end portions 138), a heat sink 252 is thermally coupled to the opposite end portions 140 of each of the batteries. The heat sink may be finned or utilize air or liquid coolant passages. In some embodiments, a fan provides air flow across a surface of heat sink 252. In at least one embodiment, the heat sink is attached or affixed to the bottom of a battery holder. The co-planar arrangement of the batteries provides a relatively flat surface to attach a heat sink and in some embodiments the battery cells are designed to cool efficiently through the bottom of the cells, e.g., 18650 lithium ion batteries.

In order to eliminate many of the drawbacks associated with wire bond interconnects, the present invention utilizes tabs that extend from the bus bars and which are directly attached to the battery terminals. Although the manufacturing approach of the invention may be used with bus bar arrangements such as that shown in FIG. 1 in which a set of bus bars and battery interconnects is used on either end of the batteries, preferably the interconnect system of the invention is used with a configuration such as that shown in FIG. 2 in which both the positive and negative battery interconnects are coupled to the batteries via a single battery end portion.

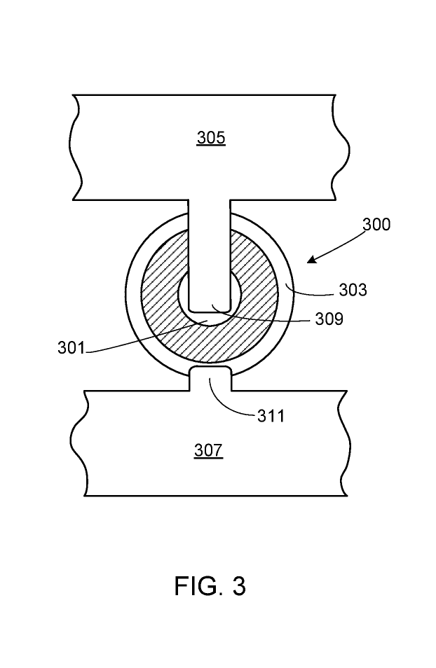

FIG. 3 provides a top view of a portion of a battery pack, and more specifically of a single battery 300, similar in design to those shown in FIGS. 1 and 2, and portions of a pair of bus bars. Battery 300 includes a raised nub 301 that serves as one terminal of the battery, typically the positive terminal, while the top edge 303 of battery 300 serves as the second terminal of the battery, typically the negative terminal. In a typical 18650 form factor battery, edge 303 is a part of the battery casing which is crimped to hold the cap assembly and the electrode assembly in place within the casing. It will be appreciated that the invention described in detail below is equally applicable to other battery configurations, for example non-cylindrical batteries.

In the illustration a pair of bus bars 305/307 is shown, where bus bar 305 is electrically connected to terminal 301 via a single interconnect 309, and bus bar 307 is electrically connected to terminal 307 via a single interconnect 311. Preferably the interconnects, i.e., interconnects 309 and 311, are fabricated in the same manufacturing process used to fabricate the corresponding bus bars. Alternately, interconnects 309 and 311 may be formed in a secondary process.

During assembly of a battery pack, an issue that may arise is arcing. If the battery, e.g., battery 300, is charged or partially charged and the interconnect is at a different potential, then when the interconnect first touches the battery terminal during the battery coupling process an arc may form at or near the point of contact between the surface of the interconnect and the battery terminal. While it is unlikely that such an arc will damage the battery or any other component of the battery assembly, it may damage the surface of the battery terminal and/or the surface of the interconnect. Typical surface damage includes surface pitting and/or surface contamination. Although visually this surface damage may appear minimal, it can increase the electrical resistance of the interconnect at the point of contact between the interconnect and the battery. Surface damage may also affect the strength of the interconnect coupling, e.g., the weld, leading to battery pack reliability issues.

In accordance with the invention, when coupling a bus bar to a battery, an initial contact is made between the two components using a sacrificial portion of the contact tab of the interconnect. Thus any arcing that may occur during the battery coupling process occurs at or near the point of contact between the sacrificial portion of the interconnect' s contact tab and the battery terminal, thus allowing the point of contact between the remaining or primary portion of the interconnect' s contact tab and the battery terminal to remain undamaged during the battery coupling process.

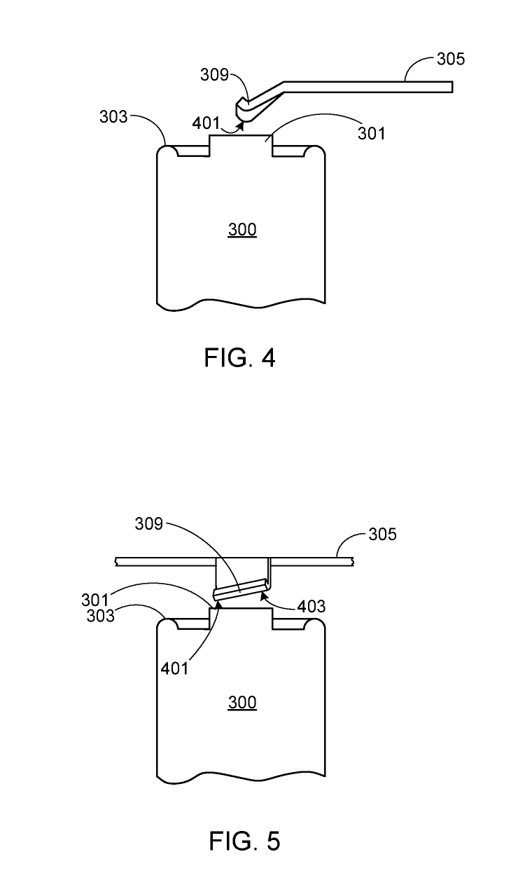

In order to provide a sacrificial portion for the interconnect, the interconnect's contact tab is pre-formed, for example twisted, in order to form an angled contact surface. The angled contact surface allows a portion of the contact tab, i.e., the sacrificial portion of the contact surface, to contact the intended battery terminal prior to the primary portion of the contact surface touching the same terminal. This aspect of the invention is illustrated in FIGS. 4 and 5, which provide orthogonal side views of battery 300 and bus bar 305. It should be understood that while the exemplary illustrations provided below are of interconnect 309 and battery terminal 301, they are equally applicable to interconnect 311 and battery terminal 303.

The views shown in FIGS. 3 and 4 are prior to engagement of any portion of interconnect 309 with battery terminal 301. As shown, interconnect 309 has been pre-formed in order to position a portion of the interconnect's contact surface, i.e., sacrificial portion 401, closer to the surface of battery terminal 301 than the remaining portion, i.e., the primary portion 403, of interconnect 309. Sacrificial contact surface 401 is configured to touch the battery terminal, e.g., terminal 301, before the primary (i.e., non-sacrificial) contact surface of interconnect 309. Given this configuration, as the battery is moved closer to the interconnects, or as the interconnects are moved closer to the battery, the sacrificial contact surface of each interconnect will touch the battery terminal before the primary contact surface of the same interconnect. Preferably the shape and relative locations of the interconnect portions are achieved by pre-shaping the interconnect during bus bar manufacturing, for example by bending each interconnect to the desired shape.

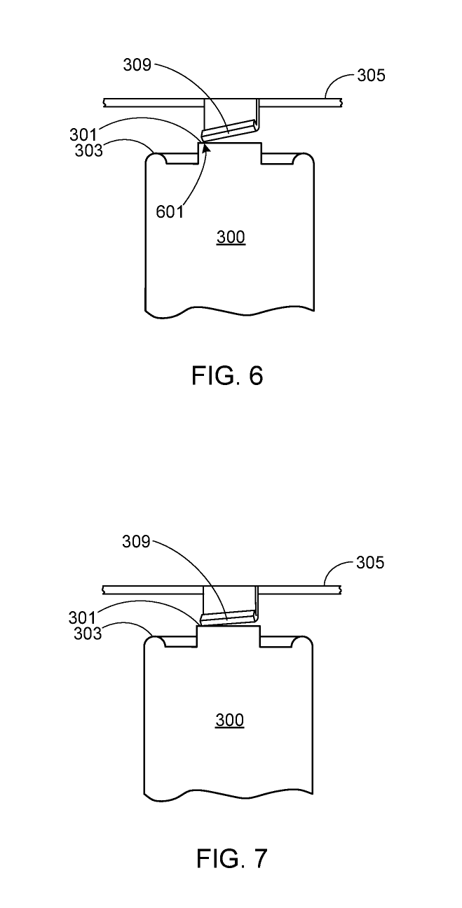

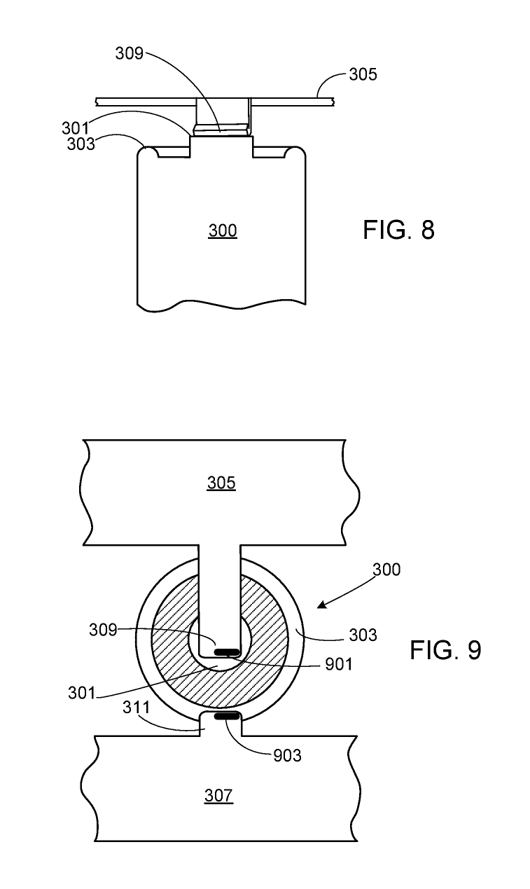

FIG. 6 provides a side view of bus bar 305, similar to the view shown in FIG. 5, after initial contact is made at region 601 between sacrificial contact surface 401 of interconnect 309 and battery terminal 301. If the interconnect experiences arcing during assembly with the battery, arcing would occur at location 601. FIG. 7 provides the same side view as the assembly procedure continues while FIG. 8 provides a final view with the interconnect fully engaged with battery terminal 301.

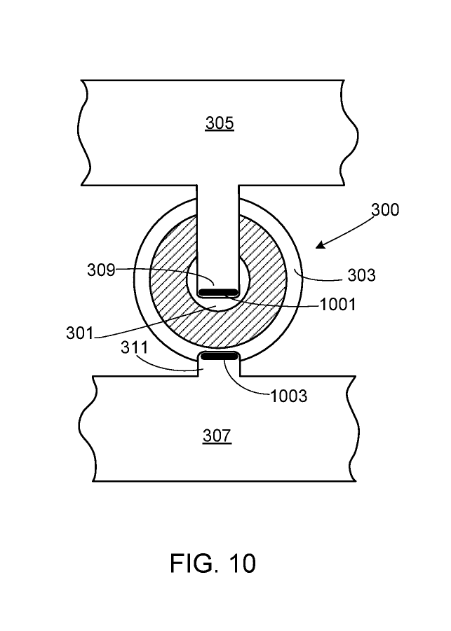

Once each of the interconnects is properly positioned relative to the battery terminals, the interconnect contacts are attached to the terminals. Preferably the interconnect contacts are laser welded in place, although it should be understood that other attachment techniques may be used such as e-beam welding, resistance welding, ultrasonic welding, thermocompression bonding, thermosonic bonding, etc. As the purpose of the sacrificial portion of each interconnect is to prevent arcing, and therefore contact damage and contamination, between the primary contact surface and the corresponding battery terminal, it is not necessary for the sacrificial contact surfaces to be welded or otherwise attached to the battery terminals. In some embodiments, however, both the sacrificial and primary contact surfaces are attached to the battery terminals. FIG. 9 illustrates the embodiment shown in FIG. 3 with the primary contact surfaces welded to the underlying battery terminals via laser weld joints 901 and 903, while the sacrificial contact surfaces remain unattached to the contacted battery terminals. FIG. 10 illustrates the embodiment shown in FIG. 3 with both the primary and sacrificial contact surfaces of each interconnect welded to the underlying battery terminals via laser weld joints 1001 and 1003.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A method of electrically interconnecting a plurality of batteries, said method comprising:
fabricating a bus bar, said bus bar comprising a plurality of interconnects configured to include at least one interconnect per battery of said plurality of batteries, said at least one interconnect per battery comprising:
a first end portion formed as an extension of said bus bar;
a second end portion distal from said first end portion and configured to be attached to a battery terminal of a corresponding battery of said plurality of batteries, wherein said second end portion is comprised of a contact tab;
pre-shaping said contact tab of said at least one interconnect per battery prior to connecting said at least one interconnect to said battery terminal, wherein said contact tab is shaped to form an angled contact surface comprised of a sacrificial contact surface and a primary contact surface, wherein said primary contact surface is distal from said sacrificial contact surface, and wherein prior to contacting said at least one interconnect to said battery terminal a first separation distance between said sacrificial contact surface and said battery terminal is less than a second separation distance between said primary contact surface and said battery terminal;
contacting said sacrificial contact surface to said battery terminal;
contacting said primary contact surface to said battery terminal, wherein said step of contacting said primary contact surface to said battery terminal is performed after completion of said step of contacting said sacrificial contact surface to said battery terminal; and
attaching said primary contact surface to said battery terminal, wherein said step of attaching forms an electrical connection between said primary contact surface and said battery terminal.

2. The method of claim 1, said step of fabricating said bus bar further comprising fabricating said at least one interconnect as a tab extending from an edge of said bus bar.

3. The method of claim 1, further comprising the step of attaching said primary contact surface to said battery terminal using a technique selected from the group consisting of laser welding, e-beam welding, resistance welding, ultrasonic welding thermocompression bonding and thermosonic bonding.

4. The method of claim 3, further comprising the step of attaching said sacrificial contact surface to said battery terminal using a technique selected from the group consisting of laser welding, e-beam welding, resistance welding, ultrasonic welding thermocompression bonding and thermosonic bonding.

5. The method of claim 1, said step of fabricating said bus bar further comprising fabricating said bus bar and said plurality of interconnects from a single piece of material.

6. The method of claim 1, said step of contacting said sacrificial contact surface to said battery terminal further comprising moving said bus bar to a first position relative to said plurality of batteries, wherein said step of moving said bus bar to said first position causes said sacrificial contact surface to touch said battery terminal.

7. The method of claim 6, said step of contacting said primary contact surface to said battery terminal further comprising moving said bus bar to a second position relative to said plurality of batteries, wherein said step of moving said bus bar to said second position causes said primary contact surface to touch said battery terminal, and wherein said step of moving said bus bar to said second position is performed after completion of said step of moving said bus bar to said first position.

8. The method of claim 1, said step of contacting said sacrificial contact surface to said battery terminal further comprising moving said plurality of batteries to a first position relative to said bus bar, wherein said step of moving said plurality of batteries to said first position causes said sacrificial contact surface to touch said battery terminal.

9. The method of claim 8, said step of contacting said primary contact surface to said battery terminal further comprising moving said plurality of batteries to a second position relative to said bus bar, wherein said step of moving said plurality of batteries to said second position causes said primary contact surface to touch said battery terminal, and wherein said step of moving said plurality of batteries to said second position is performed after completion of said step of moving said plurality of batteries to said first position.
